(19) United States
(12) Patent Application Publication
(10) Pub. No.: US 2011/0246342 A1
(43) Pub. Date: Oct. 6, 2011

(54) CONSOLIDATED INVOICING AND PAYMENT SYSTEM FOR COMMUNITIES OF MULTIPLE MEMBERS

(75) Inventors: Ryan Gibson, Waco, TX (US); Colin Heller, Waco, TX (US); Kevin Jones, Waco, TX (US)

(73) Assignee: Simple Bills, Inc., Waco, TX (US)

(21) Appl. No.: 12/891,770

(22) Filed: Sep. 27, 2010

Related U.S. Application Data
(60) Provisional application No. 61/277,739, filed on Sep. 28, 2009.

(51) Int. Cl. G06Q 30/00

(52) U.S. Cl. 705/34

(57) ABSTRACT

A method for billing community members is described herein, specifically, the method can comprise receiving a first bill from a first provider, wherein the first bill is associated with a first community debt of a community, further wherein the community comprises a plurality of community members. The method can also comprise separating the first bill into a plurality of first bill portions. Further the method can comprise transmitting each of the first bill portions to the one or more community members associated with each of the first bill portions, in community member invoices.

### BACKGROUND

This disclosure relates generally to community billing and payment systems and, more particularly, to comprehensive systems and methods for facilitating the management of invoices and payments for roommates with shared services. This disclosure also relates to the screen displays, software programs, software storage media, web applications, and related machines, components, articles and methods associated with such billing and payment systems.

Managing and paying bills can be a nightmarish struggle when there are community members such as multiple roommates, co-tenants or the like who share responsibilities for payment. Just as interpersonal relationships can be complicated, so too can the decisions about who should pay for how much of what. Fair allocation of responsibility is then complicated by disparate paying practices. One community member might want to pay everything in advance, another might need reminders, and still other community members might be routinely late even with reminders. Epitomized by the challenges of cohabitation, the situation becomes all the more acute when community members have no idea what services they will be needing to arrange for their new rooming situation, much less who to contact in order to acquire such services.

What utilities do you need and who is going to sign up for them? Who is going to make sure the bills are paid on time? Whose job is it going to be to collect each community member's share of the bill? What if one community member drops out or runs out of money when the bill is due? What will happen to the deposits if payments are late?

With community members struggling on the one hand, the corresponding service providers have equally tremendous challenges on the other side of the equation. All of their typical business challenges are seemingly dwarfed by the business challenge of dealing with high risk, notoriously inexperienced and irresponsible community members such as college student roommates. The hassles of doing business in such settings seem endless.

Hence, one can appreciate several sizable, unmet needs in relation to optimizing the billing and payment processes for roommates and the like, particularly in the student environment. Related needs include the goal to minimize unnecessary cost and complexity, to enhance ease of use, and to simplify and yet secure the billing and payment processes. This disclosure addresses these and other needs presented by the prior art. Other aspects of the disclosure include enabling this primary object while also allowing efficient management and monetization of the same. Known technology helps, but more has long been needed.

### SUMMARY

A method for billing community members is described herein, specifically, the method can, in one embodiment, comprise receiving a first bill from a first provider, wherein the first bill is associated with a first community debt of a community, further wherein the community comprises a plurality of community members. The method can also comprise separating the first bill into a plurality of first bill portions. Further the method can comprise transmitting each of the first bill portions to the one or more community members associated with each of the first bill portions, in community member invoices.

Further, an electronic database system is disclosed, Specifically the electronic database system can, in one embodiment, receive a first bill from a first provider, wherein the first bill is associated with a first community debt of a community, further wherein the community comprises a plurality of community members. The electronic database system can also separate the first bill into a plurality of first bill portions. Further, the electronic database system can transmit each of the first bill portions to the one or more community members associated with each of the first bill portions, in community member invoices.

Lastly, a computer readable medium is disclosed. Specifically, the computer usable medium, in one embodiment, has a computer readable program code embodied therein that can be adapted to be executed to implement the method described above.

### BRIEF DESCRIPTION OF THE DRAWINGS

For a more complete understanding of the present disclosure, reference is now made to the following descriptions taken in conjunction with the accompanying drawings, in which:

FIG. 1 illustrates a schematic block diagram in the prior art showing a process for invoicing community members for utilities and services and receiving payments from the communities.

FIG. 2 illustrates a schematic block diagram showing the process for consolidating invoices for utilities and services for community members and conglomerating payments from the community members to the utilities and service providers.

FIG. 3 illustrates a schematic block diagram of the electronic database (EDB) structure of the system of FIG. 2, showing data input/output and long term static and short-term variable database components.

FIG. 4 illustrates a flowchart showing five broad level routines (network setup; community setup; normal operation; anomalous operation; and community dissolution) associated with operation of the system of FIG. 2.

FIG. 5 illustrates a flowchart of network setup processes associated with the methodology of FIG. 4.

FIG. 6 is a flowchart of the community sign-on and setup processes associated with the methodology of FIG. 4.

FIG. 7 is a flowchart of the normal operation processes associated with the methodology of FIG. 4.

FIG. 8 is a flowchart of the anomalous operation processes associated with the methodology of FIG. 4.

FIG. 9 is a flowchart of the community dissolution processes associated with the methodology of FIG. 4.

### DETAILED DESCRIPTION

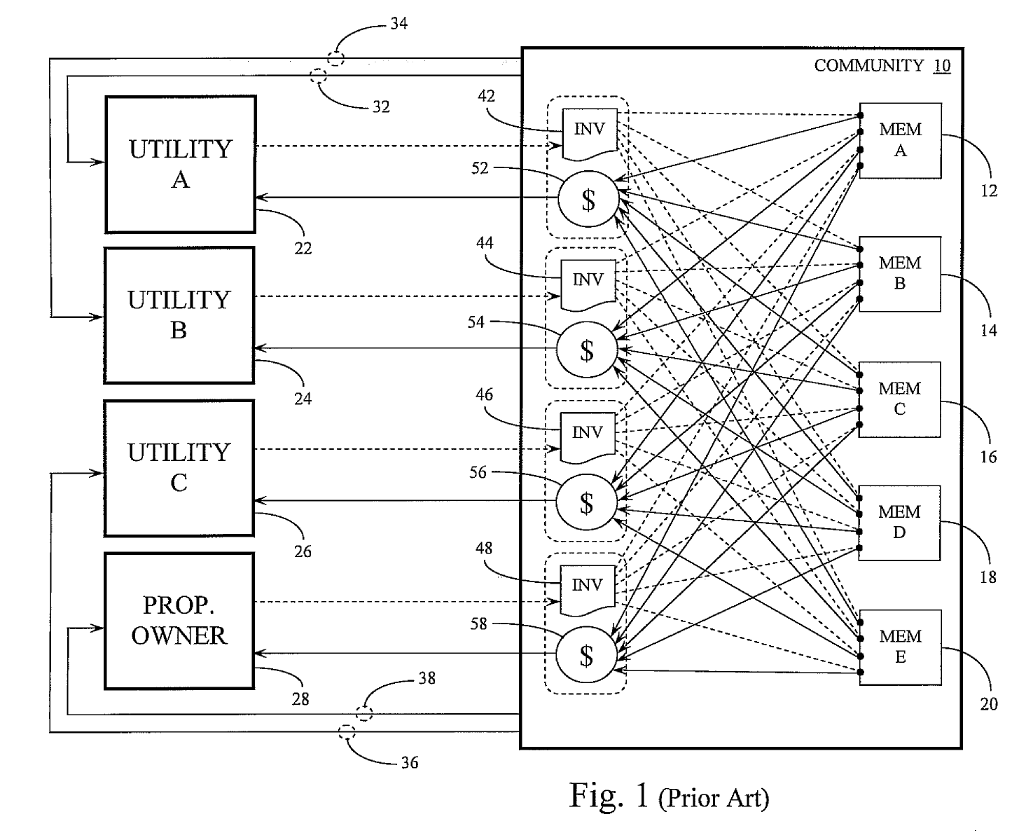

Reference is made first to FIG. 1 for a brief description of a typical existing system and methodology (prior art) for delivering invoices for utilities and service providers and for accumulating and collecting monthly payments from a community of multiple members. In the example shown, community 10 is made up of five members; including member A 12, member B 14, member C 16, member D 18, and member E 20. Community 10 may, for example, be a typical off-campus college living environment, wherein five individuals share a single household. In the typical arrangement, one member might be primarily responsible for one type of expense and the same or other members might be primarily responsible for other household expenses, but then each of the individual community members 12, 14, 16, 18, and 20 is responsible for paying to the corresponding primary members an equal (or proportioned) share of each household expense associated with the community household. So, for the illustrated household with five community members 12, 14, 16, 18, and 20, the typical arrangement theoretically results in each member being responsible for 20% of each household expense, although each household may have its own unique arrangements that result in skewed percentages, partial exemptions, etc.

In the prior art, community 10 can be served by one or more outside utilities and/or other service providers (hereinafter referred to as “providers”). The most basic provider to community 10 may, for example, be property owner 28 acting as the landlord of the property or the property manager. As with other providers, property owner 28 expects to receive a periodic payment for having provided community 10 with living space (and other services) to the community members 12, 14, 16, 18, and 20. In another embodiment, property owner 28 can be a community member. It is not necessary that property owner 28 be a resident of the property.

In addition to the owner of the property within which the community lives, a number of providers 22, 24 and 26 are anticipated. In FIG. 1, utility provider A 22 may, for example, may be an electric utility providing electrical service to community 10. Utility provider B 24 can be a water and/or sewage service provider to community 10. Utility provider C 26 can, for example, be a cable television service provider to community 10. Any number of providers can be included and would be reflected by additional entities and connections shown generally in FIG. 1.

Various living environments can include a variety of other common services that are sourced to community 10 in a unitary manner and which may be divided among community members 12, 14, 16, 18, and 20 in a similar fashion. Other such providers can include, but are not limited to, satellite television service, telephone service, internet service, lawn mowing or landscape service, natural gas and/or fuel oil service, and even subscription services for the delivery of various products, such as newspapers, groceries, etc.

In the prior art as shown in FIG. 1, each of the utilities or service providers 22, 24, 26, and 28 can deliver a paper invoice 42, 44, 46, or 48 for those services once a month to community 10. In one embodiment, Utility Provider A 22 can, for example, provide invoice 42 to community 10, while utility provider B 24 can provide invoice 44 to the community. Likewise, utility provider C 26 may provide invoice 46 to the community and property owner 28 may provide invoice 48 to the community. Although it is recognized that in most cases property owners do not provide monthly invoices to their tenants, the landlord tenancy arrangement is such that an invoice may be implied each month from which the community members must collect the rent and make payment to the owner or landlord.

Once the invoices 42, 44, 46, and 48 have been received by community 10, it is the responsibility of one or more of the members to identify the amount on each invoice and then communicate to community members 12, 14, 16, 18, and 20 each community member's appropriate share of that invoiced amount. This information communication is represented in FIG. 1 with dashed lines connecting each invoice 42, 44, 46, and 48 to members 12, 14, 16, 18, and 20. Once community members 12, 14, 16, 18, and 20 determine what each community member's share of each invoice is, then each must direct an amount of money to a collective payment 52, 54, 56, and 58 that can then be delivered to a particular respective provider 22, 24, 26, or 28.

These multiple payments from each of members 12, 14, 16, 18, and 20 are shown as solid lines in FIG. 1. These multiple payments can be collected into single payments 52, 54, 56, and 58 within community 10 before being delivered to providers 22, 24, 26, and 28. For example, the payment due to utility provider A 22 is collected into a common payment 52 from each of community members 12, 14, 16, 18, and 20. Likewise, common payment 54 is collected from each of the community members and delivered to utility provider B 24. In similar fashion, common payment 56 is collected from each of the members and delivered to utility provider C 26, and finally the proportionate share of the rent is collected in common payment 58 and delivered to property owner 28 on a monthly basis.

As can be seen from the connections shown in FIG. 1, the internal complexity within community 10 of communicating the amount of each invoice 42, 44, 46, and 48 and collecting respective payments 52, 54, 56, and 58 against those amounts from each of members 12, 14, 16, 18, and 20 creates an overly complex system of accounting, collection, payment, and delivery. It would be far more desirable to move these financial calculation activities out of community 10 as much as possible.

Some providers are typically more flexible and helpful to payment communities than others. A local monopolist, for example, tends to be less flexible, as characterized by doing less to help existing or prospective customer-community members either arrange for services or meet their payment obligations. In contrast, when community 10 has a choice of which provider to use for certain types of needed services, the providers tend to be more flexible, and Applicant has recognized that they conceivably might be willing to compensate a broker that refers customers or facilitates financial arrangements with its customers.

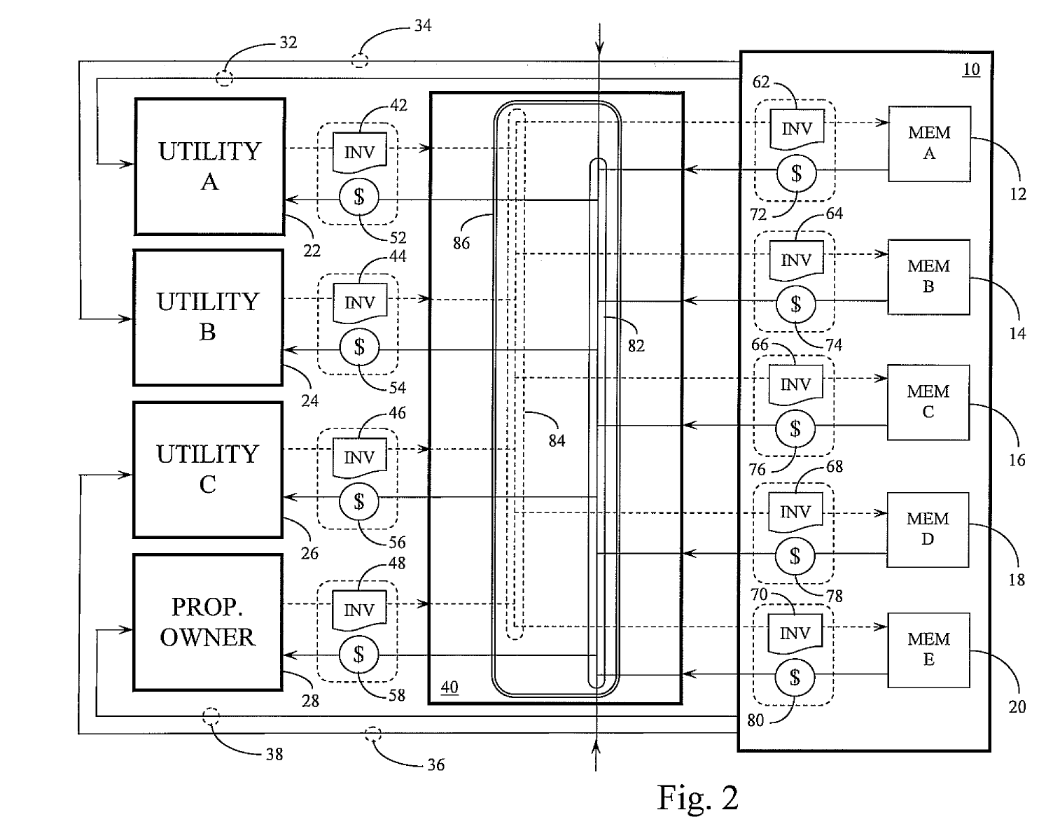

FIG. 2 illustrates a schematic block diagram showing the process for consolidating invoices for utilities and services for community members and conglomerating payments from the community members to the utilities and service providers. Many aspects of FIG. 2 are being implemented with the aid of a web-based service offered by Applicant and available at www.simplebills.com, the current contents and function of which are incorporated here by this reference. Figure illustrates an embodiment wherein community 10 is once again structured with a plurality of community members 12, 14, 16, 18, and 20, comprising member A 12, member B 14, member C 16, member D 18, and member E 20. In similar fashion, community 10 can be serviced by one or more providers 22, 24, 26, and 28 as previously described. In FIG. 2 provider A 22 can provide a first monthly service to the community that can be measured by way of metered or flat rate measurements 32. In similar fashion, provider B 24 can provide a service to community 10. Provider C 26 can also provide a service to community 10.

The system shown in FIG. 2 can further comprise a billing broker 40. Billing broker 40 can makes arrangements with each of the providers to consolidate yet properly allocate their invoices with other service provider invoices. Broker 40 then invoices the community members as individuals rather than as a group.

In this scenario shown in FIG. 2, utility provider A 22 for example, can still provide a single invoice 42 to the community but, in this embodiment, can also send a duplicate invoice in paper or electronic form to billing broker 40. Billing broker 40 can receive and consolidate the duplicate of invoice 42 with an electronic duplicate invoice 44 from provider B 24, and likewise with an electronic duplicate of invoice 46 from provider C 26 and an original or duplicate of invoice 48 from property owner 28. Alternatively, rather than sending individual duplicate invoices to broker 40, an individual provider 22, 24, 26, or property owner 28 can consolidate all of the invoice data for a plurality of community 10's managed by broker 40 into a single monthly spreadsheet with appropriate identifiers to allow broker 40 to segregate the spreadsheet data into packets of data corresponding to each of its communities.

Billing broker 40 then consolidates all of these invoices into a single total 84 which can then be allocated into individual member consolidated invoices 62, 64, 66, 68, and 70 directed to each of members 12, 14, 16, 18 and 20 within community 10. Allocation to individual member invoices 62, 64, 66, 68 and 70 can be proportionate or pro-rata (or otherwise calculated) based on the relationships chosen or entered during the community set-up process 106. Therefore, member A 12 can receive a consolidated invoice 62 while member B 14 can receive consolidated invoice 64, member C 16 can receive consolidated invoice 66, member D 18 can receive consolidated invoice 68, and member E 20 can receive consolidated invoice 70. Each consolidated invoice 68 can contain a single total that, even though it may or may not be itemized on the invoice, can comprise the sum total of the properly allocated shares of each of the actual invoices 42, 44, 46, and 48 received from providers 22, 24, 26, and 28 on behalf of community 10. “Properly allocated,” means allocated according to the relationships created during the broker account set-up process. Such allocation can remain unchanged or can be modified by authorized users or by automatic adjustments in the event of default by one or more members.

Each community member shown in FIG. 2 can make a consolidated invoice payment 72, 74, 76, 78, or 80 based on the total of his unique consolidated invoice 68, back to billing broker 40 rather than to the individual providers. Each of these consolidated invoice payments 72, 74, 76, 78, or 80 received by billing broker 40 can be recorded as having been received from community 10 as a whole in consolidated community payment 82. In this embodiment, the community members 12, 14, 16, 18 and 20 need not perform calculation and division of each of the individual utility invoices. In one embodiment, consolidated invoice can be sent to an agent of community member 72 or any other community member. In such embodiment, the agent can send consolidated invoice payment 72 on behalf of community member 72. In one embodiment, community member 72 can be a student, and the agent can be a parent of the student.

In one embodiment, broker 40 makes payments to providers only after all or a portion of consolidated invoice payments 72, 74, 76 and 78 have been paid. The portion can include all or a portion of a single consolidated invoice payment. In another embodiment, broker can makes a payment independent of whether consolidated invoice payments 72, 74, 76 and 78 have been paid or not.

While the community members 12, 14, 16, 18 and 20 can in one embodiment still receive some form of actual bill from the providers 22, 24, 26 and 28, and in some preferred embodiments, broker 40 can serve as an agent for providers 22, 24, 26 and 28 to manage accounts associated with community 10. However, in alternative embodiments, community members 12, 14, 16, 18 and 20 may still go directly to the providers 22, 24, 26 and 28 to discuss their account. In another embodiment, provider 22, 24, 26 or 28 can be broker 40.

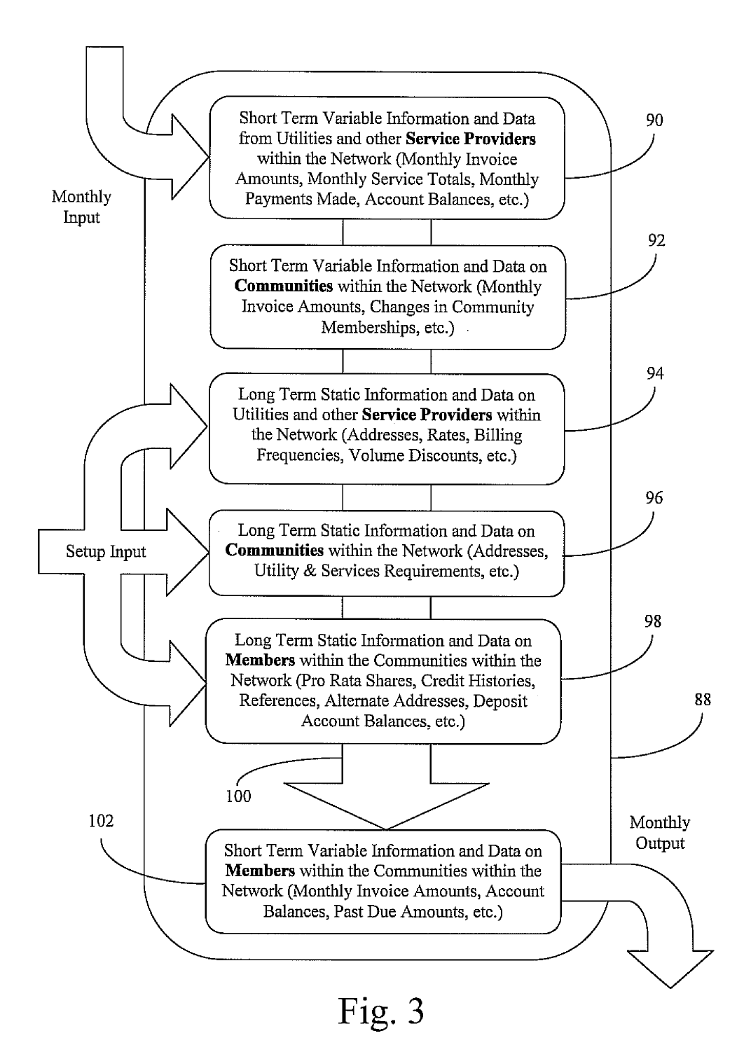

FIG. 3 illustrates a schematic block diagram of the electronic database (EDB) structure of the system of FIG. 2, showing data input/output and long term static and short-term variable database components used for establishing information and data for the purposes of the receipt, calculation, and forwarding of invoices, bills, and payments. Electronic database 88 shown in FIG. 3 is comprised of a number of long term static and short term variable database components. On the “inside” of the database are three long term static database components that maintain information regarding each of the various actors in the overall network of the system.

Electronic Database (EDB) component 94 can comprise a long-term static information and data storage area. Data storage area can include information and data on providers 22, 24, 26, and 28 within the network. The information can include, but is not limited to, provider identities, provider addresses, provider rates, broker compensation arrangements, billing frequencies, available discounts, and/or other information that might be required by broker 40 to carry out (process) a financial translation involving an invoice from provider to an individual community member by way of a share of an invoice to the community. The information and data can operate in conjunction with other long-term static information and data within the broker's EDB to carry out these calculations, typically on a monthly basis or as services are provided.

EDB component 96 can comprise long-term static information and data on community 10 and others like it. Community 10 could be identified by a name, a reference number, or even a geographic location indicator such as an address. Information can also comprise background data on particular requirements of community 10, such as established utility hook-ups (such as for cable or satellite television). Information can also identify an association between a particular type of good or service (such as water) and a provider (such as the “City of Waco”). Information may be especially important where multiple provider in a given geographic area might provide the same type of utility service (such as with various telephone or Internet service providers).

EDB component 98 can comprise data comprising long-term static information on community members 12, 14, 16, 18 and 20 of community 10. Long term information can include, but is not limited to, each community member's pro rata share of community 10's responsibility for a provider's bill, community member 12, 14, 16, 18 and 20's credit histories, references, billing address, alternate addresses, transferrable deposit account balances, and so on.

In addition to the long-term static database components described above, EDB 88 can also comprise one or more short-term electronic database components. EDB component 90 can comprise data comprising short-term variable information and data from the utilities and other service providers within the network that is initially received and/or updated, typically on a monthly basis or on an as services are provided basis. Variable information can include monthly invoice amounts, monthly service totals, monthly payments made, account balances, and so on. Variable information can also include similar information involving less frequent (every couple of months, for example) or more frequent (every two weeks, for example) invoices for services.

At this point in the electronic database, these short term variable amounts are not broken down according to members, but are instead still broken down according to communities. It is up to the processing of the EDB information by broker 40 to break down community data into member data, and of course thereafter to re-assemble member data into a consolidated invoice covering all of the utilities and service providers involved.

EDB component 92 comprises short-term variable information and data on the communities within the network. This information flows directly from EDB component 90 and includes any monthly community invoice amounts and any changes in community memberships that may have occurred in the short-term period. EDB component 92 is essentially an interface component of the database between the community referenced invoicing received from the utilities and service providers and the eventual breakdown and re-assembly (consolidation) of the data and information for the individual community members.

Finally in FIG. 3, EDB component 102 can comprise short-term variable information data on individual community 12, 14, 16, 18 and 20 members. This short-term information can come from the electronic data processing (EDP) 100, comprising the calculations, the cross-referencing, and the consolidation of the invoiced data through each of the above referenced EDB components. In such embodiment, EDB component 102 can comprise invoice amounts specific for community members 12, 14, 16, 18 and 20. Short-term variable data can also include current account balances, any past due amounts, individual deposit account balances, and so on.

FIG. 3 also illustrates data flow into and out from EDB 88. Set-up input can be initially provided to EDB components 94, 96, and 98 to establish the necessary long-term static information to carry out the calculations for breaking down provider invoices to community 10 and then re-assemble and consolidate the individual member invoice amounts. Community members 12, 14, 16, 18, and 20 can provide input to modify the short-term variable information data within EDB component 90 although short-term changes can also occur with input into EDB component 92 (for example, changes in the community membership). Output from the database can be, in one embodiment, in the form of monthly-consolidated invoices to community members 12, 14, 16, 18 and 20 deriving from the calculations and from the short-term variable information data found in EDB component 102. A further output can comprise payments from broker 40 to providers 22, 24, 26 and 28. Insofar as these are generally direct responses to the invoices broker 40 receives from providers 12, 14, 16, 18 and 20, they do not involve data processing functions along the lines of EDP 100 described above.

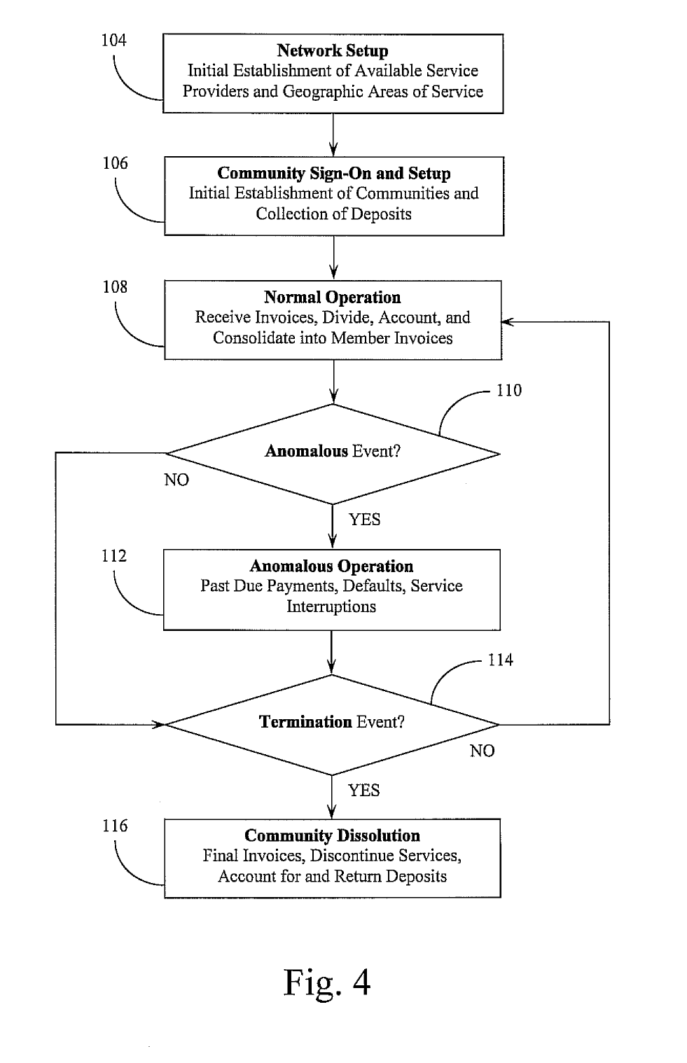

FIG. 4 provides a high level description of a basic flow of operation from initial network set-up to community 10 dissolution within the network. In particular, FIG. 4 illustrates a flowchart showing five broad level routines (network setup; community setup; normal operation; anomalous operation; and community dissolution) associated with operation of the system of FIG. 2. Initially, at operational method module 104, the network itself can be established and set up. This can include initial establishment of which providers are present within the network, as well as the network's geographic area of service. In some cases there will be little or no choice of providers for a particular good or service for community 10 within the network. In other cases there may be some opportunity to choose between multiple providers for a particular good or service.

As discussed above, services can include any goods or services. In general, the network set-up procedures can establish the necessary long-term information that broker 40 utilizes to carry out the functionality of embodiments in this disclosure. Nonetheless, the system can anticipate some changes to this set-up as new providers are identified and/or are made available to community 10.

Operational method module 106 can involve the process of initial community sign-on and set-up. In this process module, broker 40 can establish initial contact with the various communities (typically through advertising and the like), and managing members (or “originating” members) of individual communities apply to have their community carried by broker 40. The application process can include collection of information and collection of any deposits in some embodiments. This process module 106 can be carried out repeatedly throughout the lifetime of the network and may be implemented on an annual or semi-annual basis. Where communities surrounding colleges (for example) change makeup semester to semester, the process module 106 would most likely be implemented with the same frequency. At its core, the flowchart shown in FIG. 4 represents the activities and processes associated with community 10 within the overall network although each community would operate on the same principles.

Operation method module 108 can involve the normal operation of the network which is described in greater detail below, but which can include the process of receiving invoices from the service providers, dividing the invoices into identified community members' accounts, accounting for the individual member totals, and/or consolidating this information into a single member invoice that can be delivered each month or on some other periodic basis. Normal operation can account for a majority of the functionality of the system in one embodiment, as invoices are regularly received from providers 22, 24, 26 and 28, and translated into invoices delivered to community members. It is within this method module that the most significant electronic data processing occurs.

It is anticipated that with many community members, there can be some anomalous events that occur. For this reason, monitoring process 110 can provide standards for the detection of anomalous events in the normal operation of the network when these events occur. Such anomalous events may include past due payments from one or more community members, defaults by individual members, or whole communities, and service interruptions from the service providers. Various procedures, confirmed with individual members and communities upon sign on, as well as with individual service providers at network set-up, may be carried out by initiating the anomalous operations procedures associated with operational method module 112.

Because one possible outcome of many anomalous event actions is the dissolution of the community, it is appropriate to follow operational method module 112 with monitoring process 114 which provides standards for the identification of termination events. If no termination events occur, the overall process returns to normal operation within operational method module 108. If a termination event does occur, the process continues to operation method module 116 wherein the process of community dissolution takes place.

Procedures within operational method module 116 describe and define the community dissolution process, wherein after a period of time, a particular community disbands or dissolves, as its members completely leave the facilities associated with the community property, or when a significant number of individual members decide to discontinue their involvement in the brokered network. The community dissolution process within method module 116 involves the issuance of final invoices to individual community members, arranging for the discontinuance of services with the service providers, and a final accounting for and the return of any deposit amounts appropriate to the individual community members.

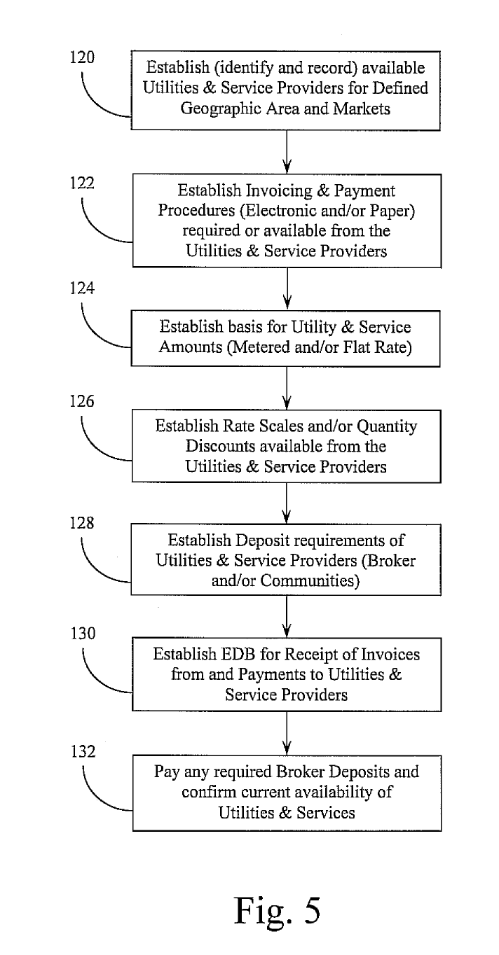

Reference is now made to FIGS. 5-9 for detailed descriptions of the individual processes (method modules) outlined generally in FIG. 4. Each of these processes can contain certain standard methodology steps, although each can envision anomalous actions that may direct the overall process into the anomalous operation procedures. FIG. 5 represents the method steps typically associated with the set-up of the system database and overall network. Generally the steps disclosed in FIG. 5 are implemented once during the establishment of the network in a given geographic area. Because utilities and service providers are typically geographic area specific, it would most often be necessary to set-up new networks in a new geographic market area, even though there may be national or even international service providers that can cross over geographic boundaries.

The process of network set-up can begin at Step 120 which involves the establishment (the identification and recordation) of available providers for the defined geographic area and markets. This step involves the categorization of the services, the storing (EDB storage described above) of contact information for the utilities and service providers, and the definition of the geographic limits of the services provided. This information provides the basis for later establishing the agreements with the communities for services.

Step 122 in the network set-up process involves the establishment of invoicing and payment procedures for each of the identified utilities and service providers. This stored information can characterize the billing and payment procedures as based in electronic and/or paper communication and would specify whether such procedures were required or were simply available from the utilities and service providers.

It is generally anticipated that the services provided to the community members by broker 40 within the network may be provided free of charge to the community members. Although dominant or less-flexible service providers may not be willing to compensate broker, broker 40 in one embodiment can be in a position to benefit from commissions and marketing fees from more flexible service providers, particularly in exchange for broker 40 promoting their services more prominently than those of their competitors. Broker 40 can also be able to benefit from volume discounts that may be associated with certain utilities and residential service providers. In other words, while the communities (the members) would be charged standard rates for the utilities and services they are provided, when broker 40 pays for these services it may receive marketing credits or the like or it may do so at a volume reduced rate. The operations of broker 40 and any profit enjoyed by broker 40 can therefore be realized in marketing and payment processing fees, as well as the difference between the standard rates and the discounted rates that it pays because of its volume “purchasing” ability. Step 124 therefore may also involve the establishment (recordal in the EDB) of the basis (metered or flat rate) for the utility and service amounts to be billed for. Step 126 involves entering an algorithm for broker's compensation arrangement with the service providers, which may include the establishment (recordal in the EDB) of the agreed flat fees, commissions, rate scales and/or volume discounts that are available from the utilities and service providers. These algorithms and corresponding arrangements may be negotiated between broker 40 and the service providers to optimize broker 40's profits from providing the network system.

Step 128 shown in the process of FIG. 5 involves the establishment (identification and recordation) of the deposit requirements (if any) of the utilities and service providers. These deposit requirements may involve only broker 40 (as a responsible payor) or may involve the communities and/or the community members. If a particular service provider requires a deposit from the community, it is anticipated that payment of the same may be integrated into the payment arrangements established between broker 40 and the community members in the same manner that monthly payments are arranged (as described in more detail below).

The final steps in the set-up process involve Step 130 wherein the EDB for receipt of invoices from and payments to providers can be established. This portion of the electronic database can provide significant throughput for the data processing system managed by broker 40 to carry out the functionality of the system. This section of the EDB can be the interface between broker 40 and the utilities and service providers where the invoiced amounts come in and the payment amounts go out. Step 132 therefore completes the set-up process wherein broker 40 pays any required deposits and confirms the current availability of providers.

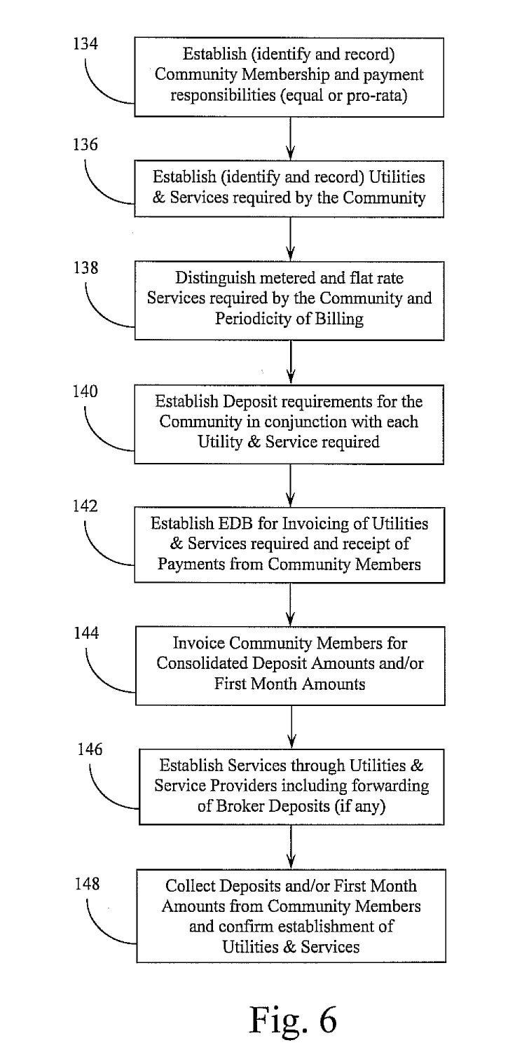

FIG. 6 discloses in greater detail the manner in which broker 40 signs up and establishes the various communities (and thereby the community members) within the network system. Step 134 initiates the process by establishing (identifying and recording) information about the community and its membership.

In some cases it is anticipated that the shares can be equal although in some cases the amounts may be unequal or pro-rata. It is not uncommon, for example, for the share of rent to be apportioned according to the size of the room that a particular community member is provided or for some members of a community to forego the enjoyment of certain “luxury” services that other in the community wish to subscribe to. The methods disclosed herein permit this unequal apportionment of any or all of the costs and expenses involved in the service.

Step 136 in FIG. 6 involves establishing (identifying and recording) the specific utilities and services required by the community. This includes linking the information in the EDB related to the appropriate service providers with the community, in many instances through an assigned account number established by the utility of service provider. It can be this mechanism that helps verify the community to which a specific invoice from the provider is directed.

Step 138 involves distinguishing metered and flat rate services required by the community and the periodicity of billing for those services. As indicated above, there may be some services that are fixed each month and can be included in the consolidated invoices to the community members without the need for a monthly invoice from the service provider. These quantities and the billing frequencies can be established in the EDB connecting the communities to specific providers.

Step 140 in FIG. 6 involves establishing deposit requirements for the community in conjunction with each utility, good or service required or simply in conjunction with broker 40. In one embodiment broker 40 can be responsible for deposits required by providers and can pass those requirements on to community 10 through consolidated deposits (similar to the consolidated invoices). In one embodiment, broker 40 can establish any necessary deposit from the community members by breaking such amounts down into the first three or four payments as an excess amount until the appropriate level of deposit is reached. In one embodiment, volume buying power of broker 40 can allow communities that would otherwise be required to provide deposits to forego the deposits or enjoy reduced deposit requirements (through broker 40), depending on the members' general credit worthiness and/or their specific credit history with broker.

The EDB for throughput of the invoicing by the utilities and service providers and the required receipt of payments from the community members is definitively established at Step 142. As mentioned above, it is through electronic data processing of this portion of the EDB that the primary functionality of the system is carried out. This EDB now has the basic information required to carry out the breakdown of the invoices from the service providers, the consolidation of the invoiced amounts into a single invoice directed to each of the community members, the breakdown of payments from the community members back to broker 40, and the conglomeration of those payments to the appropriate service providers.

Step 144 in FIG. 6 involves the process of directing invoices to the community members for any consolidated deposit amounts required and/or any first month billing amounts that may be required prior to or with the establishment of service to the community. Step 146 involves the actual establishment of services to the community through the various utilities and service providers including the forwarding of any broker deposits that may be required. In some instances the utility service may already be active at the community residence while in other cases it may be necessary to schedule a service call to activate the service. Step 148 involves the actual collection of the required deposits and/or first month amounts from the community members and the confirmation of the establishment of active utilities and services. It is anticipated that the sequence and order of Steps 144, 146, and 148 may vary depending on the requirements of the different utilities and service providers although, once again, it is anticipated that one potential benefit would be the ability of providers to rely on the established payment history of broker 40 to more readily establish services for a community upon broker 40's request.

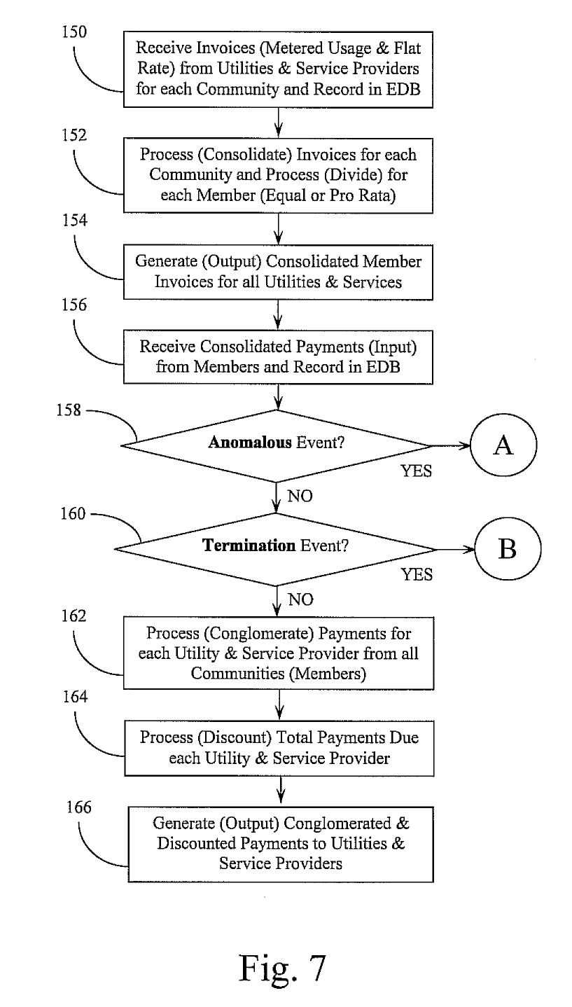

The set-up processes described in FIGS. 5 and 6 have established all of the data and the parameters required to carry out the normal (and anomalous) operation of the systems and methods in this disclosure. FIG. 7 discloses in greater detail the process of normal operations within the network. This process is generally characterized as monthly invoicing and monthly payments, and involves the general process described by the overall simplified system structure shown in FIG. 2. Step 150 in the normal operations process involves the receipt of invoices (both metered usage and flat rate) from the various utilities and service providers for each community. This invoiced information is received into the appropriate EDB as the short term variable data described above. In one embodiment, invoices can be received by broker 40 electronically and may even take the form of a database file with all communities itemized and included in a single data communication to the broker's processor. Alternately, or in conjunction with some of the service providers, it may be necessary to input the data into the broker's system by receipt of a paper invoice and the keyed entry of the relevant data. Clearly however, the highest efficiencies for all parties can be through the electronic transmission of the monthly data relating to utilities, services or goods.

Step 152 in FIG. 7 involves the core processing (consolidation) of the incoming invoices for each community and subsequent processing (division) of the consolidated amounts for each member on an equal or pro rata basis. This core processing can occur in different sequences with the same result. A first sequence can involve the consolidation of all invoices into a total for the community and the subsequent breakdown of the total into the various member shares according to an instruction from community 10. An example of another instruction is where an order of community members is given and amounts to be paid. Another example of an instruction is a combination of order and percentage. For example, an instruction can dictate that community member 12 pays the first sixty dollars of the electric bill, and any remaining amount is to be split amongst the remaining community members in equal shares. A second possible sequence can involve the application of a plurality of instructions each associated with a particular provider. In such embodiment, invoices would be split first, and then each member's obligations would be summed to create the consolidated invoice for each member. An advantage of the second approach can be the ability of the system to handle disproportionate shares for different community members that may be specific to certain invoices (services) and not to others. In the examples given above, community member 12 may pay a reduced rent for a smaller bedroom in the community house, which rate could only be accurately reflected if the share percentage of the total was applied at the service provider invoice level rather than the post-consolidation level. In any event, the system can be capable of utilizing either sequence of processing that is appropriate for the community involved.

Step 154 in FIG. 7 involves generating (outputting) the consolidated member invoices for all utilities and services provided. Step 156 involves receiving the consolidated payments (inputting) from the members and recording these in the appropriate portion of the EDB. As with the input associated with the receipt of invoices from the utilities and service providers, the system operates most efficiently where the invoices to the members, and the payments from the members, are delivered electronically. The system therefore operates most efficiently with the provision of an online portal for member access to their individual accounts with broker 40. Through this password accessible portal the member may view their account and make payments on the account. Preferably, the delivery of consolidated invoices would occur through a separate mail (email) system that does not rely on the logging in of the member for delivery of the monthly invoice or statement. In any event, while the core processing must be carried out on an EDP in conjunction with the defined EDB, the input and output functions of the system may still be handled in a set of less than fully electronic transactions. That being said, it can be one goal of the to operate as paperless as possible.

The system can integrate checks and verifications regarding the communication of information and the receipt of payments. Step 158 in FIG. 7 is a generic representation of a set of queries and checks that are in place to identify an abnormal event. Perhaps most common among the many anomalous events anticipated would be the simple failure of a member to make a timely monthly payment. If any of these anomalous events occurs, the system triggers a call to the anomalous operation of the system at Connector A in FIG. 7. Normal operation of the system for all those members not involved with anomalous events can in some embodiments continue with specific processes applied to those members involved.

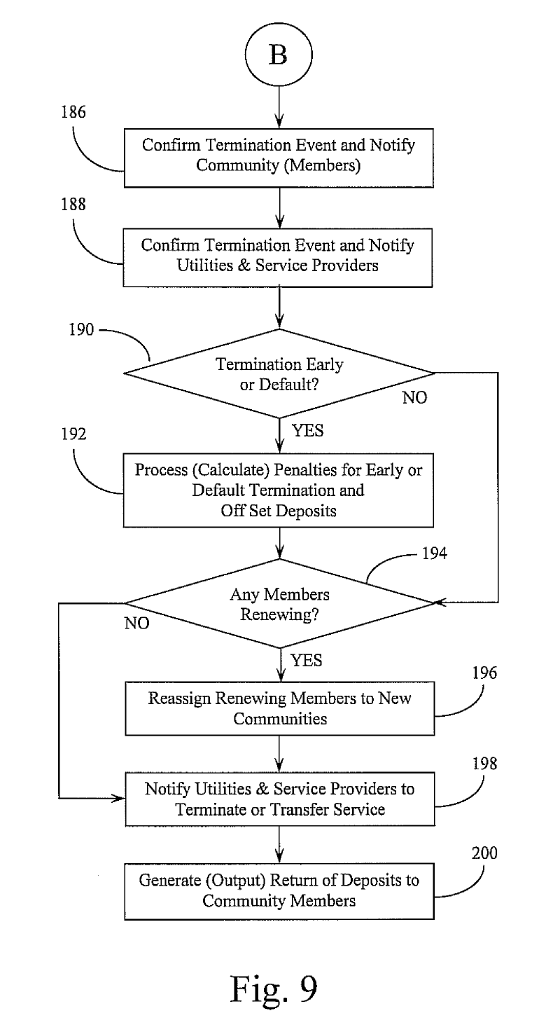

In some cases, anomalous events can lead broker 40 to receive payment from alternate payment sources such as a credit card or guarantor on file. In other cases, anomalous events are significant enough to lead to termination events. These are described in more detail below with FIG. 9. Step 160 in FIG. 7 involves a query as to whether a termination event has occurred in the normal operation of the system (whether or not an anomalous event has occurred). Certainly there can be situations in which a community would terminate its enrollment within the in the normal course of dissolving what was most likely a transient community in the first place. The system can, in one embodiment, accommodate such “normal” terminations as well as terminations resulting from anomalous events. If the process of the normal operation continues without unresolved anomalous events then the process can continue to Step 162 which involves the processing (conglomeration) of payments for each utility and service provider from all payments made by community 10.

For embodiments using volume discounts, this process can include a fictitious process insofar as the amounts received in total from the members for a particular service (electricity for example) would slightly exceed the total owed to the utility by broker 40. As described elsewhere above, in such embodiments it is through this difference that broker 40 can make additional modest profit from the transaction.

As long as broker 40 confirms receipt of or credit for the appropriate amounts from the members in a community, broker can conglomerate the amounts for a particular utility or service with amounts from other communities for that same provider. Then, after applying any credits for commissions, marketing fees, discounts or the like, broker 40 can direct a correspondingly adjusted payment to the particular provider. These latter actions are carried out at Step 164, which involves the processing of the total payments due each utility & service provider, and at Step 166, which involves generating (outputting) the conglomerated and adjusted payments to utilities and service providers. Once again, it is preferable to direct these conglomerated payments electronically where possible (given the constraints of the variety of sophisticated and unsophisticated service providers).

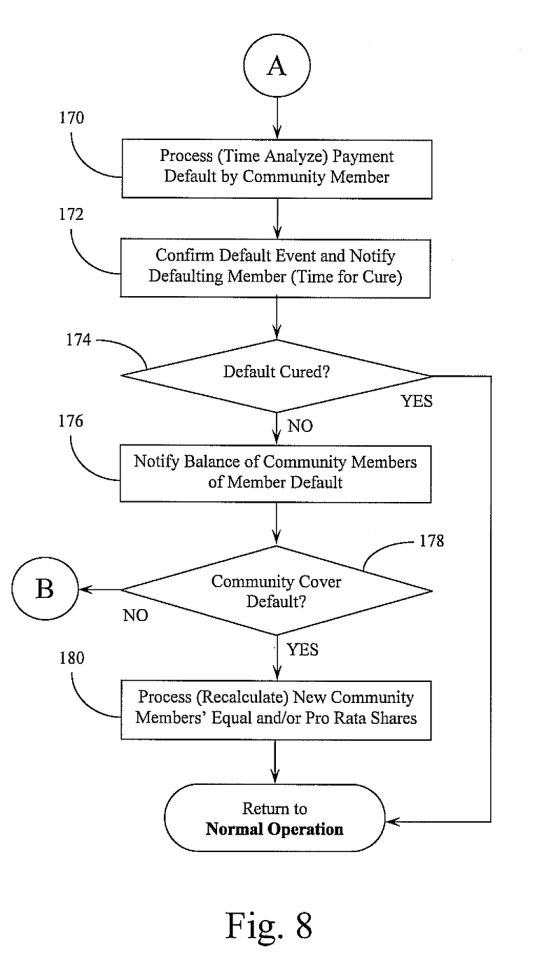

FIG. 8 addresses the basic procedures associated with the handling of anomalous events. As mentioned above, one type of anomalous event can the failure of a community member to timely make payment. The process shown in FIG. 8 therefore addresses this situation specifically, although other types of anomalous events might be anticipated and handled in much the same manner. Step 170 in FIG. 8 involves processing a time-based schedule by analyzing a calendared receipt of payments from all members operating within the network. Simply stated, the failure of a member to make payment by a certain point in time can trigger an anomalous event notice. The duration of the delay may in part serve to determine the actions taken within the anomalous event processing.

Step 172 involves confirming the default event has occurred (cross checking against the receipt of payments from other community members for example) and notifying the defaulting member of the deficiency. In one embodiment, the system can provide an opportunity for curing the anomalous event. In the situation where payment has not been received, the community member can, in one embodiment, be given a period of time to either present evidence that payment was made or to proceed to make payment, perhaps with a penalty amount. In any event, Step 174 involves a timed query as to whether the default has been cured. If the default has been timely cured by the member than the process can return to normal operations. It is worth noting that up to this point in the anomalous event processing, the other community members have not necessarily been notified. Insofar as broker 40 remains responsible for payments to the service providers, the other community members won't, in one embodiment, be in jeopardy with broker 40 or the particular provider.

If the default in question is not cured by the defaulting community member, the process can proceed to Step 176 which involves notifying the balance of the community members of one of their member's default and failure to cure. Under these circumstances community 10 can be given the opportunity to cover the defaulting member as a group in order to maintain the enrollment of the community within the system. If the community is not able to, or chooses not to, cover the default (as determined at query Step 178) then the process can proceed to the community dissolution procedures through Connector B in FIG. 8. If the community is able and chooses to cover the defaulting member than at Step 180 a re-processing (re-calculation) of the remaining community members' equal and/or pro rata shares is carried out. Various formulas can be allowed for depending on the internal agreements between the community members and instruction given to broker 40. Each remaining member may see their respective share of the total rise or one or more members may agree to absorb the defaulting members share on an unequal basis. In any event, from the standpoint of broker 40, it is only necessary that the total invoiced amounts be covered as the manner in which these amounts are divided among the community members is less critical to the processing of the invoices and payments.

Finally reference is made to FIG. 9 which describes in greater detail the manner in which the enrollment of a community within the network may be terminated. Once again, invoking the termination processes may be the result of the community running its normal life span (a year of college for example) or may be the result of an unresolved or irresolvable anomalous event. In either case, this process can provide for the orderly discontinuance of services and the retention or return of any deposits remaining. Further, the system provides specific mechanisms whereby community members may easily transition into new communities within the network upon the dissolution of their initial community.

Step 186 in FIG. 9 involves confirming the termination event and notifying all of the community members. This can involve the occurrence of a time based expiration agreed to at the establishment of the community in which case termination procedures can be automatically initiated or may involve the community simply providing adequate notice to broker 40 of their intended dissolution. Step 188 involves further confirmation of the termination event through notification of the same to the relevant utilities and service providers. This initial notice to providers 22, 24, 26 and 28 can allow them to generate final invoices and the like and to anticipate a specific date for actual discontinuance of services.

At some point in the process (at Step 190 in FIG. 9) it can be recognized whether the termination should be considered early or the result of an anomalous event. Established agreements may determine whether early termination results in penalties and/or the loss of deposits. If termination is routine or planned then the process proceeds to query Step 194. If termination is the result of an anomalous event (an uncured default for example) or an early notice from the community, then Step 192 is implemented whereby a processing (calculation) of any agreed upon penalties for early or default termination is carried out. Alternately, this step in the process could simply result in the retention of a deposit by broker 40 or a reduction in the amount of the deposit returned to the community members involved.

As indicated above, the system can in one embodiment, make it easy for a community member to transition into a new community upon the dissolution of the first community. Step 194 involves a query as to whether any members of the dissolving community can be in a position to renew their involvement in the network through enrollment in a new or different community. If not the process proceeds to Step 198. If there are transferring or renewing members then Step 196 initiates the process for renewing a member or a group of members and/or reassigning the renewing members to new communities. This process can involve the retention of deposits already established with broker 40 or the waiver of such deposits after a positive payment history. In any case the system can, in one embedment, provide an ability for an individual to move into a new community without all of the hassles normally associated with transferring utilities and other services.

Finally, the community dissolution process winds up with Step 198 wherein broker 40 notifies one or more providers to actually terminate or transfer service. This second notification can confirm disconnection dates and can verify that such service terminations have occurred. This notification also provides the opportunity for broker 40 to alert the utility or service provider to a possible new establishment of service or the transfer of service for one or more renewing members within the system. Step 200 involves generating (outputting) any required return of by broker 40 deposits to non-renewing community members as well as the receipt of such deposits back from the service providers that may have required the same for a specific community property.

One embodiment involves the use of a desktop computer system as a convenience kiosk for making the methods disclosed herein readily available to students in or near their apartment manager's office. The kiosk computer system may be a conventional computer system that is preloaded with necessary software for implementing aspects of this disclosure through interactive screen displays and/or through access to a web-based application that enables the same. By positioning such a kiosk in close proximity to the property manager's office, the manager is readily able to point students to a mutually beneficial solution to the needs of the students (such as the needs to find and manage payments for necessary utilities for the apartment) as well as the needs of the manager (such as the need to reduce the risk of student non-payment of rent when due).

In related business methods, the operator of the broker system provides the added incentive of paying a set referral fee to the apartment manager for each account that is initiated using the kiosk system located in or near the manager's office. Such referral business methods are tracked to the referring manager's credit either due to the location of the corresponding kiosk or through an identifying number on a referral card that the manager gives to the prospective member such that the member enters the number when initiating a community set-up process 106, thereby tracing the credit to the source of the referral card.

Those of skill in the art will also understand that aspects of this disclosure can involve or be used in other types of billing/paying relationships as well. So, even though some aspects of this disclosure provide exceptional benefits in the college roommate setting where students need help setting-up and coordinating payments for common services, aspects of this disclosure may be applied and appreciated for other types of transactions or in other settings as well. One alternative embodiment, for instance, adds customizable fields to the preferred embodiments described previously. With the addition of broadly-customizable fields in addition to the established frameworks for rent, utilities and other services, roommates or others can use the enhanced embodiment for facilitating payment for virtually any item. Hence, if three of four roommates wish to purchase a flatscreen TV under an extended payment plan, the broadly-customizable field is available to accommodate such a purchase and facilitate the corresponding payments. Another alternative embodiment is adapted to offer comparable benefits to other special populations, such as young professionals, rather than students.

Similarly, still other variations are to be made commercially available by Applicant under the designations “Necessities” to promote a variety of other types of products to users of the preferred embodiments and to offer students a flexible range of options for paying for the same. The variety of products that can be made more available in such manner may be unlimited but includes car washes, oil changes, computer repairs, handy man services, laundry services, grocery services and purified water delivery services, or even charitable giving accounts. For grocery services, only staple groceries such as bread, eggs and milk are provided in order to keep decisions simple for roommates using the service. Once such other products are included in the utility provision service of broker 40, the corresponding bills are combined with the monthly utility bills and can be paid by check, money order, automatic draft or credit card online

Still other embodiments relate to application-specific machines that incorporate software to achieve the methods according to the teachings reflected herein, as well as subsystems, macrosystems or methods for performing all or part of the processes described or inferred herein. While there are many variations within the scope of this disclosure, one of ordinary skill in the art should consider the scope of this disclosure from a review of the claims appended hereto (including any amendments made to those claims in the course of prosecuting this and related applications) as considered in the context of the prior art and the various descriptions of this application.

Numerous variations, substitutions, modifications and simplifications will still fall within the scope of this disclosure that are the subject of this application. Many other features, benefits and advantages of the inventions related to the embodiments referenced herein will be evident to those of skill in the art in light of an exhaustive review of the prior art. Even though the foregoing embodiments represent the most preferred at present, those of ordinary skill in the art will recognize many possible alternatives that we have not expressly suggested here. While the foregoing written descriptions enable one of ordinary skill to make and use what is considered presently to be best modes of the invention, those of ordinary skill will understand and appreciate the existence of variations, combinations, and equivalents of the specific embodiment, method, and examples herein. It should be understood that the drawings and detailed descriptions herein are to be regarded in an illustrative rather than a restrictive manner, and are not intended to limit the invention to the particular forms and examples disclosed. To the contrary, the invention includes any further modifications, changes, rearrangements, substitutions, alternatives, design choices, and embodiments apparent to those of ordinary skill in the art, without departing from the spirit and scope of this invention, as defined by any claims included herewith or later added or amended in an application claiming priority to this present filing. The invention covers all embodiments within the scope and spirit of such claims, irrespective of whether such embodiments have been remotely referenced here or whether all features of such embodiments are known at the time of this filing. Thus, it is intended that the claims be interpreted to embrace all further modifications, changes, rearrangements, substitutions, alternatives, design choices, and embodiments that may be evident to those of skill in the art. In any case, all substantially equivalent systems, articles and methods should be considered within the scope of the present invention.

1. A method for billing community members comprising
receiving a first bill from a first provider, wherein the first bill is associated with a first community debt of a community, further wherein the community comprises a plurality of community members;
separating the first bill into a plurality of first bill portions; and
transmitting each of the first bill portions to the one or more community members associated with each of the first bill portions, in community member invoices.

2. The method of claim 1 wherein the first provider is a utility provider.

3. The method of claim 1 wherein the first provider is a service provider.

4. The method of claim 1 wherein separating the first bill into a plurality of first bill portions comprises
receiving a first instruction from the community describing how to apportion the first bill, and
separating the first bill into the plurality of first bill portions according to the first instruction.

5. The method of claim 4 wherein the first instruction comprises a first plurality of percentages, each associated with the one or more community members.

6. The method of claim 1 further comprising the steps
receiving a second bill from a second provider, wherein the second bill is associated with a second community debt of the community;
separating the second bill into a plurality of second bill portions; and
transmitting each of the second bill portions to the one or more community members associated with each of the second bill portions, in the community member invoices.

7. The method of claim 6 wherein separating the second bill into a plurality of second bill portions comprises
receiving a second instruction from the community describing how to apportion the second bill, and
separating the second bill into the plurality of second bill portions according to the second instruction.

8. The method of claim 7 wherein the second instruction comprises a second plurality of percentages, each associated with the one or more community members.

9. The method of claim 7 wherein the second instruction is the first instruction.

10. The method of claim 1 wherein transmitting each of the first bill portions to the one or more community members comprises sending at least one of the first bill portions to an agent of at least one of the community members.

11. An electronic database (EDB) system that
receives a first bill from a first provider, wherein the first bill is associated with a first community debt of a community, further wherein the community comprises a plurality of community members;
separates the first bill into a plurality of first bill portions; and
transmits each of the first bill portions to the one or more community members associated with each of the first bill portions, in community member invoices.

12. The EDB system of claim 11 wherein the server sends at least one of the first bill portions to at least one of the community members by email.

13. The EDB system of claim 11 wherein the server initiates a print sequence to create a paper copy of at least one of the first pill portions to be sent to at least one of the community members.

14. The EDB system of claim 11 that, to separates the first bill into a plurality of first bill portions,
receives a first instruction from the community describing how to apportion the first bill, and
separate the first bill into the plurality of first bill portions according to the first instruction.

15. The EDB system of claim 14 wherein the first instruction comprises a first plurality of percentages, each associated with the one or more community members.

16. The EDB system of claim 14 wherein the server further
receives a second bill from a second provider, wherein the second bill is associated with a second community debt of the community;
separates the second bill into a plurality of second bill portions; and
transmits each of the second bill portions to the one or more community members associated with each of the second bill portions, in the community member invoices.

17. The EDB system of claim 16 that, to separate the second bill into a plurality of second bill portions,
receives a second instruction from the community describing how to apportion the second bill, and
separates the second bill into the plurality of second bill portions according to the second instruction.

18. The EDB system of claim 17 wherein the second instruction comprises a second plurality of percentages, each associated with the one or more community members.

19. The EDB system of claim 17 wherein the second instruction is the first instruction.

20. A computer usable medium having a computer readable program code embodied therein, wherein the computer readable program code is adapted to be executed to implement the method of claim 1.
